(19) United States
(12) Patent Application Publication
(10) Pub. No.: US 2009/0118387 A1
(43) Pub. Date: May 7, 2009

(54) Method for Producing Water-Absorbing Polyurethane Foam

(75) Inventor: Kenichi Sakakibara, Anjo-shi (JP)

Correspondence Address: CROMPTON, SEAGER & TUFTE, LLC, 1221 NICOLLET AVENUE, SUITE 800, MINNEAPOLIS, MN, 55403-2420, US

(73) Assignee: INOAC CORPORATION, Nagoya-shi (JP)

(21) Appl. No.: 11/936,591

(22) Filed: Nov. 7, 2007

(51) Int. Cl. C08G 18/82

(52) U.S. Cl. 521/170

(57) ABSTRACT

A water-absorbing polyurethane foam is produced by reacting, foaming, and curing a raw material which includes aliphatic or alicyclic polyisocyanate, polyester polyol, a polyoxyethylene compound for a hydrophilizing agent, a catalyst and a blowing agent. Thus obtained water-absorbing polyurethane foam has a coating film made from a cured substance of the foam formed on both surfaces. The content of the polyoxyethylene compound in the raw material is 1 to 10 parts by mass with respect to 100 parts by mass in total of the polyester polyol and the polyoxyethylene compound. The raw material is reacted, foamed, and cured at a temperature of 40 to 130° C. The polyisocyanate has an isocyanate index of preferably 85 to 100.

### BACKGROUND OF THE INVENTION

The present invention relates to a method for producing a water-absorbing polyurethane foam used as a hemostatic pad, for instance.

Conventionally, a non-woven fabric gauze having water absorption property so as to relieve discomfort due to sweat has been used as a material to be adhered to a skin, for instance, a hemostatic pad. However, such gauze has problems that some fibers are released from the main body of the hemostatic pad and bonded to the skin during use, and the shape is lost when replaced. Under the circumstances, a polyurethane foam, which is a porous body, has been proposed in Japanese Laid-Open Patent Publication No. 2005-48038.

This polyurethane foam is obtained by subjecting a liquid mixture of organic polyisocyanate, polyol, a catalyst, a blowing agent, and a foam stabilizer to reaction, foaming and curing steps. The organic polyisocyanate includes an allophanate-modified organic polyisocyanate composition formed from a compound containing an alcoholic hydroxyl group and an aliphatic or alicyclic diisocyanate. The average number of functional groups of the polyol is 2 to 6, and the number average molecular weight of the polyol is 100 to 20,000. The polyurethane foam prevents discoloration due to ultraviolet light, nonuniform formation of cells due to unbalanced reactivity, and the production of a scorch.

The polyurethane foam according to Japanese Laid-Open Patent Publication No. 2005-48038 prevents discoloration or the like, since it employs an aliphatic or alicyclic diisocyanate as an organic polyisocyanate. However, the polyurethane foam is a common soft foam obtained through a urethane-forming reaction of the aliphatic or alicyclic diisocyanate with a polyester polyol or a polyether polyol, and accordingly has no adequate hydrophilicity. Therefore, the polyurethane foam has a problem of being incapable of performing a required function when used in an application requiring sufficient water absorption property, for instance, a hemostatic pad, because of the insufficient water absorption property.

### SUMMARY OF THE INVENTION

An objective of the present invention is to provide a method which easily produces a water-absorbing polyurethane foam that inhibits discoloration and shows an excellent water absorption property.

To achieve the foregoing objective and in accordance with one aspect of the present invention, a method for producing a water-absorbing polyurethane foam is provided. The method includes: preparing a raw material which includes aliphatic or alicyclic polyisocyanate, polyester polyol, a polyoxyethylene compound as a hydrophilizing agent, a catalyst, and a blowing agent; and reacting, foaming, and curing the raw material to form the water-absorbing polyurethane foam. The polyoxyethylene compound occupies 1 to 10 parts by mass in the raw material with respect to 100 parts by mass in total of the polyester polyol and the polyoxyethylene compound. The temperature of the raw material is set to a value between 40° C. to 130° C. while being reacted, foamed, and cured.

### BRIEF DESCRIPTION OF THE DRAWINGS

FIG. 1 is a schematic view illustrating a cross-section of a water-absorbing polyurethane foam according to an embodiment; and

FIG. 2 is a diagrammatic view illustrating an apparatus for producing the water-absorbing polyurethane foam.

### DETAILED DESCRIPTION OF THE PREFERRED EMBODIMENTS

An embodiment according to the present invention will now be described in detail below with reference to the drawings.

A method for producing a water-absorbing polyurethane foam according to the present embodiment includes the steps of reacting, foaming, and curing a raw material of the water-absorbing polyurethane foam. When the raw material of the water-absorbing polyurethane foam is reacted, foamed and cured, the temperature of the raw material is set at 40 to 130° C. The raw material of the water-absorbing polyurethane foam includes aliphatic or alicyclic polyisocyanate, polyester polyol, a polyoxyethylene compound as a hydrophilizing agent, a catalyst and a blowing agent. In the following description, the water-absorbing polyurethane foam is referred to simply as a foam.

The Polyester polyol has low compatibility with a polyoxyethylene compound, which is a hydrophilizing agent. Accordingly, when the foam is produced, the hydrophilizing agent bleeds to the surface of the foam and enhances the hydrophilicity of the foam. The polyester polyol includes, for instance: a condensed polyester polyol obtained through a reaction of a polycarboxylic acid and a polyol; a lactic polyester polyol; a polycarbonate polyol; and modified compounds thereof. These polyester polyols may be contained alone or in a combination of two kinds or more. The polycarboxylic acid includes, for instance, adipic acid and phthalic acid. The polyol includes, for instance, ethylene glycol, diethylene glycol, propylene glycol and glycerine.

The number of functional groups of hydroxyl group and hydroxyl value in the polyester polyol may be varied by adjusting, for instance, the ingredient type, molecular weight, and condensation degree of a raw material of the polyester polyol. The hydroxyl value of the polyester polyol is preferably 20 to 200 mg KOH/g, and further preferably is 50 to 80 mgKOH/g. When the hydroxyl value of the polyester polyol is less than 20 mgKOH/g, the hydroxyl value of the polyester polyol is excessively small to decrease the crosslink density of the foam and consequently lower the shape retentiveness of the foam. When the hydroxyl value exceeds 200 mgKOH/g, the hydroxyl value of the polyester polyol is excessively large to increase the crosslink density of the foam and harden the foam. Furthermore, the foam tends to have closed cell structure, in which most of each cell is closed with each other.

The aliphatic or alicyclic polyisocyanate has a plurality of isocyanate groups and reacts with polyester polyol. The aliphatic polyisocyanate includes, for instance, hexamethylene diisocyanate (HDI), lysine diisocyanate (LDI), butene diisocyanate (BDI), 1,3-butadiene-1,4-diisocyanate, octamethylene diisocyanate, and a modified compound thereof. The alicyclic polyisocyanate includes, for instance, isophorone diisocyanate (IPDI), dicyclohexylmethane diisocyanate, hydrogenerated diphenylmethane diisocyanate (hydrogenerated MDI), hydrogenerated xylene diisocyanate (hydrogenerated XDI), cyclohexane diisocyanate, methylcyclohexane diisocyanate, and dicyclohexylmethane diisocyanate. These polyisocyanates may be contained alone or in a combination of two kinds or more.

The raw material may include polyisocyanate having three or more isocyanate groups per molecule as the polyisocyanate, in addition to the above described aliphatic or alicyclic polyisocyanate. The polyisocyanate having three or more isocyanate groups per molecule include, for instance, lysine ester triisocyanate, 1,8-diisocyanate-4-isocyanate methyl octane, 1,6,11-undecane triisocyanate, 1,3,6-hexamethylene triisocyanate, and bicycloheptane triisocyanate. These specific examples may be contained alone or in a combination of two kinds or more. Among these specific examples, lysine ester triisocyanate and 1,3,6-hexamethylene triisocyanate are preferable. The polyisocyanate having three or more isocyanate groups per molecule are used together with the above described diisocyanate, for instance. In this case, the content of the polyisocyanate having three or more isocyanate groups per molecule is preferably 60 mass % or lower of the total mass of the polyisocyanate by a ratio.

An isocyanate index of the polyisocyanate is preferably 85 to 100. The isocyanate index is an equivalent ratio of an isocyanate group of the polyisocyanate to the total of a hydroxyl group of the polyester polyol, a hydroxyl group of the polyoxyethylene compound and an active hydrogen group of the blowing agent such as water, expressed by percentage. Accordingly, the isocyanate index of less than 100 means that the hydroxyl group and the active hydrogen group are excessive in comparison with the isocyanate group, and the isocyanate index of more than 100 means that the isocyanate group is excessive in comparison with the hydroxyl group and the active hydrogen group. When the isocyanate index is less than 85, the polyester polyol cannot sufficiently react with the polyisocyanate. A reaction of a resin is suppressed. As a result, the foam may become sticky and the foam may deteriorate its physical properties, for instance, strength. When the isocyanate index exceeds 100, the isocyanate group becomes excessive and the foam may become excessively stiff.

The polyoxyethylene compound as a hydrophilizing agent is a polymerized or modified ethylenic compound, and imparts hydrophilicity to the foam. The polyoxyethylene compound has low compatibility with the above described polyester polyol. Therefore, when the foam is produced, the polyoxyethylene compound is considered to bleed to the surface of the foam to show hydrophilicity. The polyoxyethylene compound includes, for instance, polyethylene oxide or a modified compound thereof and polyoxyethylene alkylether. Polyethylene oxide and the modified compound thereof have one, two, or three hydroxyl groups per molecule and polyoxyethylene alkylether has one hydroxyl group per molecule. These polyoxyethylene compounds may be contained alone or in a combination of two kinds or more. The raw material may include, for instance, a polyoxypropylene compound as a hydrophilizing agent, in addition to the polyoxyethylene compound. In this case, the raw material mainly includes the polyoxyethylene compound as a hydrophilizing agent. It is not suitable for the raw material to include the polyoxypropylene compound singly for a hydrophilizing agent, because of the insufficient hydrophilicity.

The polyoxyethylene compound has a number-average molecular weight of preferably 200 to 1,000. When the number-average molecular weight of the polyoxyethylene compound is less than 200, the polyoxyethylene compound may hardly bleed to the surface of the foam. When the number-average molecular weight of the polyoxyethylene compound exceeds 1,000, the polyoxyethylene compound tends to promptly react with the polyisocyanate and the foam may not acquire sufficiently enhanced hydrophilicity.

The content of the polyoxyethylene compound in the raw material is 1 to 10 parts by mass with respect to 100 parts by mass in total of the polyester polyol and the polyoxyethylene compound, so as to make the polyoxyethylene compound sufficiently show its function. When the content of the polyoxyethylene compound is less than 1 part by mass, the polyoxyethylene compound does not show the function sufficiently. As a result, the foam cannot acquire adequate hydrophilicity, and cannot show water absorption property sufficiently. When the content of the polyoxyethylene compound exceeds 10 parts by mass, the balance of a raw material composition is degraded due to the excessive polyoxyethylene compound, and the adequate foam cannot be obtained.

The catalyst promotes a urethane-forming reaction between the polyisocyanate and the polyester polyol. Examples of the catalyst include, for instance, a tertiary amine, an amine having a diamino group, potassium 2-ethyl hexanoate, an acetate, an alkali metal alcoholate, and an organometallic compound. Examples of the tertiary amine include, for instance, N,N′,N′-trimethylaminoethylpiperazine, triethylenediamine, and dimethylethanolamine. Examples of the amine having the diamino group include, for instance, 1,8-diazabicyclo(5,4,0)undecene-7. Examples of the organometallic compound include, for instance, tin octoate. These specific examples may be contained alone or in a combination of two kinds or more. Among the specific examples, the tertiary amine and the amine having the diamino group are more preferable, because of their capability of inhibiting the yellowing of the foam.

The blowing agent foams the raw material of the foam and forms the foam. Examples of the blowing agent include, for instance water, pentane, cyclopentane, hexane, cyclohexane, dichloromethane, methylene chloride, and carbon dioxide. These blowing agents may be contained alone or in a combination of two kinds or more. The raw material of the foam may include, for instance, a foam stabilizer such as a surface active agent, a fire retardant such as a condensed phosphate, an antioxidant, a plasticizer, an ultraviolet absorbing agent, and a coloring agent, in addition to the above described ingredients.

In order to cause the above described urethane-forming reaction between the polyisocyanate and the polyester polyol, a one-shot process or a prepolymer technique is adopted. The one-shot process is a process of directly reacting the polyester polyol with the polyisocyanate. The prepolymer technique is a technique, for instance, of reacting the total amount of one of the polyester polyol and the polyisocyanate with a part of the other beforehand to obtain a prepolymer having an isocyanate group or a hydroxyl group in a terminal, and then reacting the product with the rest of the other. The one-shot process is a method preferable to the prepolymer technique because it requires only one production step, has little restriction of production conditions, and is consequently capable of reducing production costs.

The foam is produced by a complicated reaction, but is basically includes the following main reactions: an addition polymerization reaction (urethane-forming reaction or resin-forming reaction) between the polyisocyanate and the polyester polyol; a foaming reaction between the polyisocyanate and the blowing agent; and a crosslinking reaction (curing reaction) between these reaction products and the polyisocyanate.

Thus obtained foam is a flexible foam having an open cell structure. In the foam, cells connect with each other to show water absorption property. In a closed cell foam, cells do not connect with each other, so that no water enters the inside of the cells. Accordingly, the closed cell foam does not function as a water absorption material. In order to obtain the open cell structure, it is preferable to set a period during which the raw material exists in a cream state (cream time) at about 10 to 40 seconds, in the above described foaming step, and set a period (rise time) from when the raw material has been injected till when the forming reaction proceeds most briskly and foams become highest at about 1 to 6 minutes.

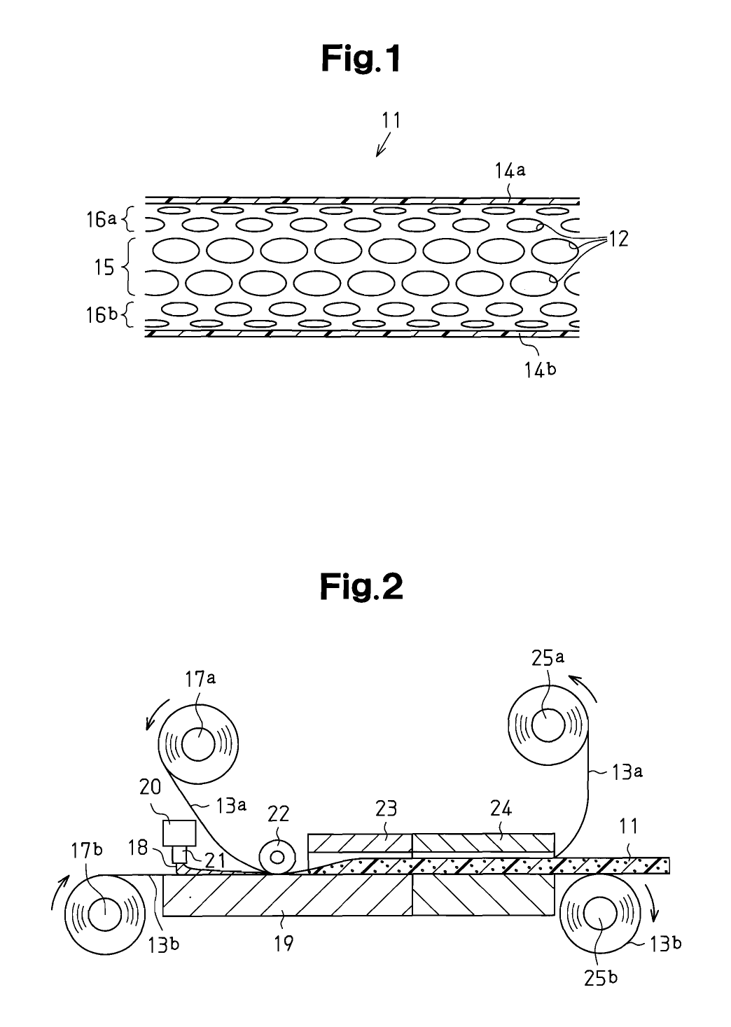

The foam according to the present embodiment is produced with the use of a production apparatus shown in FIG. 2, and has a cross-sectional structure shown in FIG. 1. As is shown in FIG. 1, coating films 14a, 14b made of the cured substance in the foam are formed on both surfaces of the foam 11 having a sheet shape. Since the coating films 14a, 14b have the thickness of about 2 to 50 μm, the foam 11 shows sufficient water absorption property. The foam 11 has a low density layer 15 formed in its central part. The foam 11 also has high density layers 16a, 16b having higher density than that of the low density layer 15 formed between the low density layer 15 and the coating films 14a and between the low density layer 15 and the coating films 14b. Specifically, a cell 12 (bubble) formed through a foaming reaction is larger in the center of the foam 11, and becomes small as the cell approaches to the surface of the foam 11. Therefore, the density of the foam 11 is small in the center, and is large between the center and the coating film 14a and between the center and the coating film 14b. There are four or five cells 12 in a thickness direction of the foam 11. The cells 12 connect with each other, and the foam 11 has an open cell structure. FIG. 1 schematically shows the structure of the foam 11, but does not show the open cell structure.

The production apparatus for producing the foam 11 has a pair of upper and lower delivery rollers 17a, 17b, as is shown in FIG. 2. Release films 13a, 13b are coiled around the delivery rollers 17a, 17b, respectively, and both release films 13a, 13b are sent out forward (to the right side in FIG. 2) so as to overlap with each other. In the above movement, the lower delivery roller 17b rotates right-handedly, and the upper delivery roller 17a rotates left-handedly. A material of the release films 13a, 13b includes, for instance, a fluorine resin and a silicone resin.

In a lower part of the upper delivery roller 17a, a raw material supply device 20 is arranged which discharges a raw liquid material 18 of the foam 11 through a supply port 21 that is opened downward. The raw material 18 discharged from the supply port 21 of the raw material supply device 20 is supplied onto the release film 13b which is sent out from the lower delivery roller 17b and supported on a support 19. A pressure roller 22 is arranged ahead of the raw material supply device 20. The pressure roller 22 presses both release films 13a, 13b from above in a state of making the raw material 18 sandwiched between both release films 13a and 13b, and adjusts the thickness between both release films 13a and 13b.

Ahead of the pressure roller 22, a first heater 23 is arranged which heats the raw material 18 to a temperature between 40° C. to 130° C. and causes the reaction and foaming in the raw material. Ahead of the first heater 23, a second heater 24 is arranged which heats the raw material 18 to a temperature between 50° C. to 100° C. and cures the raw material 18. When the first heater 23 heats the material 18 to a temperature lower than 40° C., the material 18 is not resinified sufficiently through the reaction. When the first heater 23 heats the material 18 to a temperature exceeding 130° C., the foam 11 is deteriorated by heat and becomes brittle. As a result, an adequate foam 11 is not obtained. When the second heater 24 heats the material 18 to a temperature lower than 50° C., the foam 11 is cured insufficiently and hardly acquires adequate hardness. When the second heater 24 heats the material 18 to a temperature exceeding 100° C., the curing reaction excessively proceeds not to form an interconnecting cell structure. In the present embodiment, the support 19 and the first heater 23 are integrally structured.

Ahead of the second heater 24, a pair of upper and lower coiling rollers 25a, 25b are arranged. Release films 13a, 13b sent out of the second heater 24 are coiled around the coiling rollers 25a, 25b, respectively. Specifically, the raw material 18 sandwiched between the release films 13a, 13b reacts and foams in the first heater 23, and cures (cross-links) in the second heater. Thereafter, the release films 13a, 13b are then coiled around the coiling rollers 25a, 25b, respectively. As a result, the foam 11 is produced which has coating films 14a, 14b and high density layers 16a, 16b formed on both surfaces. The foam 11 has a thickness of preferably about 0.5 to 10 mm. In such a case, the foam 11 has a density of about 80 to 350 kg/m³.

When the foam 11 is produced, the production apparatus shown in FIG. 2 is used. The raw material 18 is supplied from the raw material supply device 20 onto the release film 13b, and the raw material 18 is supplied into the first heater 23 and the second heater 24, in a state of being sandwiched between the release films 13b and 13a. The obtained foam 11 has coating films 14a, 14b and high density layers 16a, 16b formed on both surfaces, and shows adequate water absorption property. This is assumed to be because the polyoxyethylene compound having low compatibility with the polyester polyol gradually bleeds to the surface of the foam 11 along with the progress of a resin-forming reaction and foaming reaction between the polyisocyanate and the polyester polyol in the process of producing the foam 11, and the raw material 18 is cured in the state. Therefore, the obtained foam 11 acquires hydrophilicity, and shows the hydrophilicity particularly on the surface based on the polyoxyethylene compound. Furthermore, films of cells 12 formed through a foaming reaction are broken due to the above described composition of the raw material 18 and a foaming condition, and consequently the cells 12 connect with each other to form an open cell structure. Accordingly, the water which has entered the foam 11 immediately passes through the cells 12 communicating with each other, and is absorbed into the foam 11.

The present embodiment has the advantages described below.

The raw material 18 employed for producing the foam 11 according to the present embodiment includes the aliphatic or alicyclic polyisocyanate, which do not have a benzene ring. Therefore, the obtained foam 11 hardly causes discoloration. In addition, the raw material 18 includes the polyoxyethylene compound to impart hydrophilicity to the foam 11, and the content of the polyoxyethylene compound is set at 1 to 10 parts by mass with respect to 100 parts by mass in total of the polyester polyol and the polyoxyethylene compound. The polyoxyethylene compound has low compatibility with the polyester polyol. Accordingly, the polyoxyethylene compound tends to bleed to the surface of the foam 11, and can increase the water absorption property of the foam 11. Thus, the foam 11 is easily produced by adjusting the composition of the raw material and setting the temperature during the reaction at 40 to 130° C.

The foam 11 can be easily produced by using the alicyclic polyisocyanate as the polyisocyanate to retard a urethane-forming reaction.

A resin-forming reaction can sufficiently proceed and the polyisocyanate can be prevented from remaining in the foam 11, by setting an isocyanate index of the polyisocyanate at 85 to 100.

The foam 11 is easily formed into a sheet shape having the flat surface and coating films 14a, 14b and high density layers 16a, 16b are easily formed on both surfaces of the foam 11, by supplying the raw material 18 on the release film 13b, reacting, foaming, and curing the raw material and then separating the release films 13a, 13b from the raw material.

Having excellent water absorption property, the foam 11 according to the present embodiment is suitably used as a hemostatic pad, a napkin, a paper diaper and a shoulder pad or the like.

The present embodiment may be modified as described below.

The foam 11 may be produced with, for instance, a molding method or a pour-in-situ method by spray molding.

The foam 11 may be produced by cutting a slab of a polyurethane foam into a sheet shape. The slab of the polyurethane foam is obtained by discharging the raw material onto a belt conveyor, making the raw material naturally foam at ordinary temperature (25° C.) and under ambient pressure (0.1 MPa) while the belt conveyor moves, and then curing the foam in a drying furnace.

At least one of coating films 14a, 14b and high density layers 16a, 16b may be omitted, or alternatively their thicknesses may be changed, for instance, by changing a temperature above and below the release films 13a, 13b, which sandwich the raw material 18, in the first heater 23.

The above described embodiment will now be further specifically described below with reference to examples and comparative examples.

### EXAMPLES 1 TO 8 AND COMPARATIVE EXAMPLES 1 TO 7

Raw materials of a foam having compositions shown in Table 1 and Table 2 were prepared, and the foam was produced by using the above described production apparatus and method. The temperatures of the first heater 23 were set at temperatures shown in Table 1 and Table 2, and the temperature of the second heater 24 was set at 70° C. The meanings of abbreviated words in Table 1 and Table 2 will be shown below. In Table 1 and Table 2, numeric values in columns showing each component of the raw material is expressed by part by mass. Each obtained foams was subjected to the evaluation of appearance and the measurement of density, water absorption property and yellowing properties according to a method which will be described below. The results are shown in Table 1 and Table 2.

N2200: polyester polyol made by Nippon Polyurethane Industry Co., Ltd.; having molecular weight of 2,200 and hydroxyl value of 60 mgKOH/g;

PEM 300: polyethylene oxide added monool having one hydroxyl group per molecule made by Lion Corporation; having hydroxyl value of 187 mgKOH/g and molecular weight of 300;

NL-70: polyoxyethylene lauryl ether having one hydroxyl group per molecule made by Sanyo Chemical Industries Ltd.; having hydroxyl value of 111 mgKOH/g;

PEG 600: polyethylene oxide (polyethylene glycol) having two hydroxyl groups per molecule made by Sanyo Chemical Industries Ltd.; having hydroxyl value of 187 mgKOH/g and molecular weight of 600;

PP-600: polypropylene glycol having two hydroxyl groups per molecule made by Sanyo Chemical Industries Ltd.; having hydroxyl value of 187 mgKOH/g and molecular weight of 600;

GE-1000: polyethylene oxide added triol having three hydroxyl groups per molecule made by Lion Corporation; having hydroxyl value of 168 mgKOH/g and molecular weight of 1,000;

G-700: polypropylene oxide added triol having three hydroxyl groups per molecule made by Asahi Denka Kogyo K.K.; having hydroxyl value of 240 mgKOH/g and molecular weight of 700;

IPDI: isophorone diisocyanate

HDI: hexamethylene diisocyanate

TDI: tolylene diisocyanate (mixture of 80 mass % 2,4-tolylene diisocyanate and 20 mass % 2,6-tolylene diisocyanate); product name T-80 made by Nippon Polyurethane Industry Co., Ltd.;

DBU: catalyst; 1,8-diazabicyclo (5,4,0) undecene-7 made by San-Apro, Ltd.;

Kaolizer No. 25: tertiary amine catalyst made by Kao Corporation;

DABCO K-15: catalyst; diethylene glycol solution of potassium 2-ethyl hexanoate made by Sankyo Air Products Co., Ltd.; and

B8300: silicone foam stabilizer made by Goldschmidt Corporation

### (Appearance)

The appearance of each foam was visually inspected.

### (Density)

The density (kg/m³) of each foam was measured according to a method specified in JIS K 7222; 1999 of Japanese Industrial Standard (ISO 845 of an international standard).

### (Water Absorption Property)

A period of time (seconds) after 0.5 ml of water were dripped on the surface of each foam by using a dropping pipette and before the water was completely absorbed in the foam was measured.

### (Yellowing Property)

A color difference (ΔYI) was evaluated by the steps of: putting a foam sample of each example in a desiccator; adding 10 ppm of nitrogen dioxide (NO₂) gas; and measuring the yellowing degree (whiteness degree) of the sample by using a color-difference meter (SM color computer SM-4 made by Suga Test Instruments Co., Ltd.). The color difference (ΔYI) was evaluated based on a criterion described below. The criterion is that when ΔYI is 1.5 or less, the color change is less than a sensible level for the human eye.

0 to 0.5: trace of color difference, 0.5 to 1.5: slight color difference, 1.5 to 3.0: noticeable color difference by human eye, 3.0 to 6.0, 6.0 to 12.0: much color difference, 12.0 or more: very much color difference

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| N2200 | 95 | 95 | 99 | 90 | 95 | 95 | 95 | 95 |
| PEM300 | 5 | — | — | — | — | — | — | — |
| NL-70 | — | 5 | — | — | — | — | — | 5 |
| PEG-600 | — | — | 1 | 10 | — | 5 | 5 | — |
| GE-1000 | — | — | — | — | 5 | — | — | — |
| IPDI | 29 | 33 | 30 | 32 | 33 | 26 | — | 33 |
| HDI | — | — | — | — | — | — | 24 | — |
| Isocyanate index | 100 | 100 | 100 | 100 | 100 | 85 | 100 | 100 |
| DBU | 0.4 | 0.4 | 0.4 | 0.4 | 0.4 | 0.4 | 0.4 | 0.4 |
| K-15 | 0.4 | 0.4 | 0.4 | 0.4 | 0.4 | 0.4 | 0.4 | 0.4 |
| B8300 | 1.4 | 1.4 | 1.4 | 1.4 | 1.4 | 1.4 | 1.4 | 1.4 |
| Water | 1.4 | 1.4 | 1.4 | 1.4 | 1.4 | 1.4 | 1.4 | 0.5 |
| Temperature (° C.) | 40 | 130 | 120 | 90 | 60 | 75 | 80 | 130 |
| of first heater | | | | | | | | |
| Appearance | good | good | good | good | good | good | good | good |
| Density (kg/m³) | 180 | 170 | 186 | 185 | 177 | 169 | 168 | 320 |
| Water absorption | 4 | 5 | 3 | 4 | 42 | 7 | 6 | 5 |
| property (sec) | | | | | | | | |
| Yellowing | 1.02 | 0.86 | 0.77 | 0.91 | 0.75 | 1.12 | 0.98 | 0.86 |
| property (ΔYI) | | | | | | | | |

According to the results shown in Table 1, the appearance of the foam 11 was adequate and the density was 168 to 320 kg/m³, in Examples 1 to 8. A necessary period of time for absorbing water was 42 seconds or shorter, and most of the examples showed 7 seconds or shorter. From the result, the foam 11 was thought to have satisfactory water absorption property. All examples also showed yellowing properties in an unnoticeable level for the human eye, as is shown by 1.12 or less of ΔYI. Example 6 was prepared by using a raw material of a lowered isocyanate index of 85, but showed no problem in the yellowing properties though the value is slightly high (1.12) and showed satisfactory water absorption property as well. Example 7 was prepared by using HDI, which is an aliphatic isocyanate, but showed both satisfactory water absorption property and yellowing properties. Example 8 was prepared by using a reduced amount of water as a blowing agent, and accordingly showed the increased density of 320 kg/m³, but showed both satisfactory water absorption property and yellowing properties. Examples 1 to 6 and example 8 were prepared by using isophorone diisocyanate as the alicyclic polyisocyanate, so that the raw material proceeded the urethane-forming reaction more slowly than that in Comparative Example 1 prepared by using tolylene diisocyanate, and the foam 11 was more easily produced than that in Comparative Example 1.

TABLE 2

| | C. Ex. 1 | C. Ex. 2 | C. Ex. 3 | C. Ex. 4 | C. Ex. 5 | C. Ex. 6 | C. Ex. 7 |
|---|---|---|---|---|---|---|---|
| N2200 | 100 | 95 | 95 | 95 | 95 | 99.5 | 89 |
| PEG-600 | 3 | 5 | 5 | — | — | 0.3 | 17 |
| PP-600 | — | — | — | 5 | — | — | — |
| G-700 | — | — | — | — | 5 | — | — |
| IPDI | — | 31 | 31 | 29 | 33 | 29 | 32 |
| TDI | 24 | — | — | — | — | — | — |
| Isocyanate index | 104 | 100 | 100 | 100 | 100 | 100 | 100 |
| DBU | — | 0.4 | 0.4 | 0.4 | 0.4 | 0.4 | 0.4 |
| Kaorizer No25 | 0.6 | — | — | — | — | — | — |
| K-15 | — | 0.4 | 0.4 | 0.4 | 0.4 | 0.4 | 0.4 |
| B8300 | 1.4 | 1.4 | 1.4 | 1.4 | 1.4 | 1.4 | 1.4 |
| Water | 1.4 | 1.4 | 1.4 | 1.4 | 1.4 | 1.4 | 1.4 |
| Temperature (° C.) | — | 35 | 133 | 70 | 70 | 70 | 70 |
| of first heater | | | | | | | |
| Appearance | good | poor | crumbled | good | good | good | Foam not |
| | | resinification | polyurethane | | | | obtained |
| Density (kg/m³) | 65 | — | — | 175 | 190 | 188 | — |
| Water absorption | 3 | — | — | one minute | one minute | one minute | — |
| property (sec) | | | | or longer | or longer | or longer | |
| Yellowing property | 22.37 | — | — | 0.83 | 0.95 | 1.05 | — |
| (ΔYI) | | | | | | | |

On the other hand, according to the result shown in Table 2, Comparative Example 1 prepared by using tolylene diisocyanate, which is an aromatic diisocyanate as polyisocyanate, showed satisfactory water absorption property but poor yellowing properties. This is considered to be because a benzene ring of tolylene diisocyanate was converted to a quinoid. Comparative Example 2 was prepared by reacting, foaming, and curing the raw material at a temperature of 35° C., so that the material did not sufficiently proceed with a resin-forming reaction because the temperature was excessively low. Comparative Example 3 was prepared by reacting, foaming and curing the raw material at a temperature of 133° C., so that the foam was crumbled because the material excessively proceeded the resin-forming reaction due to excessively high temperature. Comparative Examples 4 and 5 were prepared by using a polypropylene compound as a hydrophilizing agent, so that the foam did not acquire sufficient hydrophilicity and took one or more minutes for absorbing water completely. Comparative Example 6 was prepared so as to contain 0.3 parts by mass of the hydrophilizing agent, and the foam did not acquire sufficient hydrophilicity and took one or more minutes for absorbing water completely. Comparative Example 7 was prepared so as to contain 17 parts by mass of the hydrophilizing agent, then the hydrophilicity was excessive, and the hydrophilizing agent excessively bled to the surface of the foam. As a result, a satisfactory foam was not obtained.

1. A method for producing a water-absorbing polyurethane foam comprising:
preparing a raw material which includes aliphatic or alicyclic polyisocyanate, polyester polyol, a polyoxyethylene compound as a hydrophilizing agent, a catalyst, and a blowing agent;
providing a lower release film and an upper release film overlapping the first release film;
supplying the raw material onto the lower release film;
reacting, foaming and curing the raw material while the raw material is sandwiched between the lower release film and the upper release film to form the water-absorbing polyurethane foam; and
separating the lower release film and the upper release film from the water-absorbing polyurethane foam;
wherein the polyoxyethylene compound occupies 1 to 10 parts by mass in the raw material with respect to 100 parts by mass in total of the polyester polyol and the polyoxyethylene compound, and
wherein the temperature of the raw material is set to a value between 40° C. to 130° C. while being reacted, foamed, and cured.

2. The method according to claim 1, wherein the polyisocyanate is an alicyclic polyisocyanate.

3. The method according to claim 1, wherein the polyol and the polyoxyethylene compound have a hydroxyl group, the blowing agent has an active hydrogen group, and the polyisocyanate has an isocyanate group in an amount of 85 to 100 by an isocyanate index, which represents an equivalent ratio expressed by percentage of the isocyanate group in the polyisocyanate with respect to the total of hydroxyl groups in the polyol and the polyoxyethylene compound and the active hydrogen group of the blowing agent.

4-5. (canceled)

6. The method according to claim 1, wherein the polyester polyol has a hydroxyl value of 20 to 200 mgKOH/g.

7. The method according to claim 1, wherein the polyoxyethylene compound has the number average molecular weight of 200 to 1,000.

8. The method according to claim 1, wherein the temperature of the raw material is set to a value between 40° C. to 130° C. while reacting and foaming, and to a value between 50° C. to 100° C. while foaming.

9. The method according to claim 1, wherein the water-absorbing polyurethane has a sheet shape.

10. The method according to claim 9, wherein the water-absorbing polyurethane foam is continuously produced.

11. The method according to claim 9, wherein coating films formed of the cured substance in the water-absorbing polyurethane foam are formed on both sides of the water-absorbing polyurethane foam.

12. The method according to claim 11, wherein the coating films have a thickness of 2 to 50 μm.

13. The method according to claim 9, wherein the water-absorbing polyurethane foam has a thickness of 0.5 to 10mm.
